(19) United States
(12) Patent Application Publication
(10) Pub. No.: US 2005/0057094 A1
(43) Pub. Date: Mar. 17, 2005

(54) System for regulating the supply of power to a brake system

(76) Inventor: Robert L. Koelzer, Kearney, MO (US)

Correspondence Address: ST. ONGE STEWARD JOHNSTON & REENS, LLC, 986 BEDFORD STREET, STAMFORD, CT, 06905-5619, US

(21) Appl. No.: 10/663,397

(22) Filed: Sep. 16, 2003

(51) Int. Cl. B60T 8/32

(52) U.S. Cl. 303/121

(57) ABSTRACT

A system for regulating the supply of power to a brake system is disclosed generally comprising an engine, an intermediate device driven by the engine, a power source driven by the intermediate device, a brake system powered by the brake source, and a controller that communicates with the intermediate device to regulate the supply of power to the brake system. In some embodiments, the intermediate device includes a supply device and a motor for receiving an agency, such as fluid or electricity, from the supply device.

### FIELD OF THE INVENTION

The present invention relates to system of regulating the rate at which power is supplied to a brake system. More specifically, the invention relates to a system employing a controller and an intermediate device, which is driven by an engine and which drives a brake power source, to regulate the rate at which the power source supplies power to the brake system.

### BACKGROUND OF THE INVENTION

The principles governing the deceleration and stopping of a motor vehicle are generally well known. A moving vehicle possesses kinetic energy, which must be removed in order for the vehicle to slow or stop. This removal of kinetic energy is most generally achieved by converting this energy into heat via friction. Hence, if a driver of a vehicle desires to slow or stop a vehicle faster than the vehicle would normally slow or stop as a result of the frictional force between the vehicle's wheels and the road, an additional frictional force must be applied. This additional conversion of kinetic energy into heat is usually performed by applying a contact material—typically in the form of a block or a pad—to the rotating wheels or to discs attached to the axles. As friction is created and the kinetic energy is thereby converted into heat, the wheels slow down and eventually the vehicle stops.

In order to apply this contact material, a power supply is obviously required. Systems for supplying power to a brake system are also generally well known, and typically include a power source, such as a compressor or an electric generator, that is driven by the crankshaft of the vehicle's engine. Such an arrangement allows power to be continuously available, which may be required for a variety of reasons. For example, in cases where the power is utilized to engage the braking mechanism, such as by causing a caliper to pinch a rotating disc, a driver who wants to brake often or immediately on demand will always have the appropriate power available to power the caliper. Similarly, in cases where power is needed to disengage the braking mechanism, such as in the case where a caliper is normally biased against a rotating disc by a spring, which must be biased in the opposite direction by pressurized fluid in order to release the brakes, power can be supplied to the braking system continuously in order to keep the vehicle moving.

However, one disadvantage with this way of supplying power to the brake system occurs in vehicles that operate at low engine speeds for long periods of time, such as inter-city buses, school buses, and refuge trucks. As a result, the power supply must be very large in order to meet the overall needs of the vehicle's braking system.

What is desired, therefore, is a system of supplying power to a brake system that permits engines to run at low speeds for long periods of time. What is further desired is a system of supplying power to a brake system that does not require the use of a large power source. What is also desired is a system of supplying power to a brake system that conserves energy.

### SUMMARY OF THE INVENTION

Accordingly, it is an object of the present invention to provide a system for regulating the supply of power to a brake system that does not require the use of a large power source in vehicles where the engine must run at low speeds for long periods of time.

It is a further object of the present invention to provide a system for regulating the supply of power to a brake system that conserves energy when the brake system does not require power.

To overcome the deficiencies of the prior art and to achieve at least some of the objects and advantages listed, the invention comprises a system for regulating the supply of power to a vehicle's brake system, including an engine, an intermediary device driven by the engine, a brake power source driven by the intermediary device, a brake system powered by the brake power source, and a controller in communication with the intermediary device, the controller, in response to a minimum engine speed, causing the intermediary device to drive the brake power source at a desired rate.

In another embodiment, the invention comprises a system for regulating the supply of power to a vehicle's brake system, including an engine, an intermediary device driven by the engine, a source of pressurized fluid driven by the intermediary device, a brake system powered by the source of pressurized fluid, and an electronic control unit in communication with the intermediary device, the controller, in response to a minimum engine speed, causing the intermediary device to drive the source of pressurized fluid at a desired rate.

In yet another embodiment, the invention comprises a system for regulating the supply of power to a vehicle's brake system, including an engine, an intermediary device driven by the engine, a source of electricity driven by the intermediary device, a brake system powered by the source of electricity, and an electronic control unit in communication with the intermediary device, the controller, in response to a minimum engine speed, causing the intermediary device to drive the source of electricity at a desired rate.

### BRIEF DESCRIPTION OF THE DRAWINGS

FIG. 1 is a block diagram of a system for regulating the supply of power to a brake system in accordance with the invention.

FIG. 2 is a block diagram of one specific embodiment of the system of FIG. 1.

FIG. 3 is a block diagram of another specific embodiment of the system of FIG. 1.

FIG. 4 is a block diagram of another specific embodiment of the system of FIG. 2.

FIG. 5 is a block diagram of another specific embodiment of the system of FIG. 2.

FIG. 6 is a block diagram of a specific embodiment of the system of FIG. 5.

FIG. 7 is a block diagram of another specific embodiment of the system of FIG. 5.

FIG. 8 is a block diagram of a specific embodiment of the system of FIG. 5.

FIG. 9 is a block diagram of a specific embodiment of the system of FIG. 8.

### DETAILED DESCRIPTION OF THE DRAWINGS

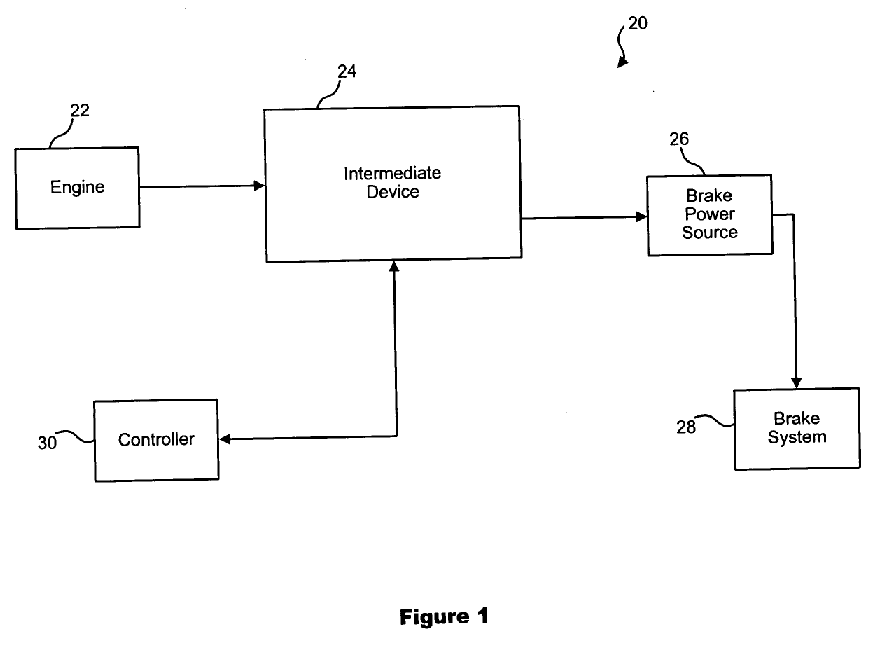

The basic components of one embodiment of a system 20 for regulating the supply of power to a vehicle's brake system in accordance with the invention are illustrated in FIG. 1. Typically, the system 20 includes an engine 22, which drives an intermediate device 24, usually via crankshaft (not shown). The intermediate device 24, in turn, drives a brake power source 26, which supplies power to a brake system 28. A controller 30 communicates with the intermediate device 24 in order to regulate the rate at which the intermediate device drives the brake power source 26. In this way, the brake power source 26, though ultimately driven by the crankshaft of the engine 22, need not necessarily be driven at the same speed at which the crankshaft turns. Accordingly, the controller 30 can, in response to a minimum engine speed, cause the intermediate device 24 to drive the brake power source 26 at a desired rate.

Typically, the controller 30 is an electronic control unit (ECU). In certain embodiments, an operator of the vehicle can effect complete control over the electronic control unit 30, and thus, can directly regulate the rate at which the intermediate device 24 drives the brake power source 26. In other embodiments, the electronic control unit 30 has one or more inputs that effect the rate at which the brake power source 26 is driven, as is further explained below.

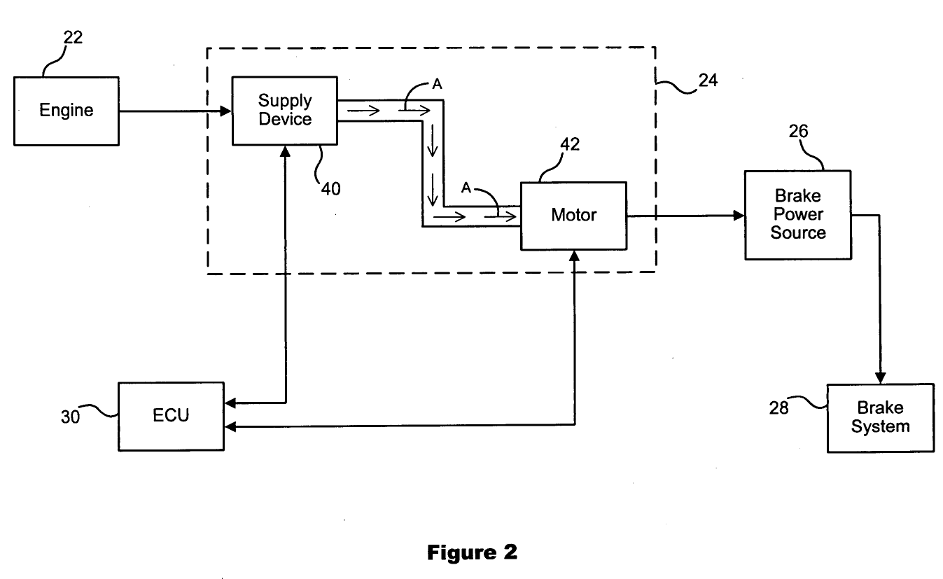

In certain embodiments, the intermediate device 24 includes two separately housed components. The basic components of one such embodiment of the intermediate device 24 are illustrated in FIG. 2. In this embodiment, the intermediate device 24 includes a supply device 40 and a motor 42. The supply device 40, which is driven by the crankshaft of the engine 22, supplies an agency (indicated by arrows A), such as fluid or electricity, to the motor 42. The motor 42, which is driven by the agency, in turn, drives the brake power source 26. Accordingly, by regulating the amount of the agency that is supplied to the motor 42 by the device 40, the rate at which the brake power source 26 is driven is controlled.

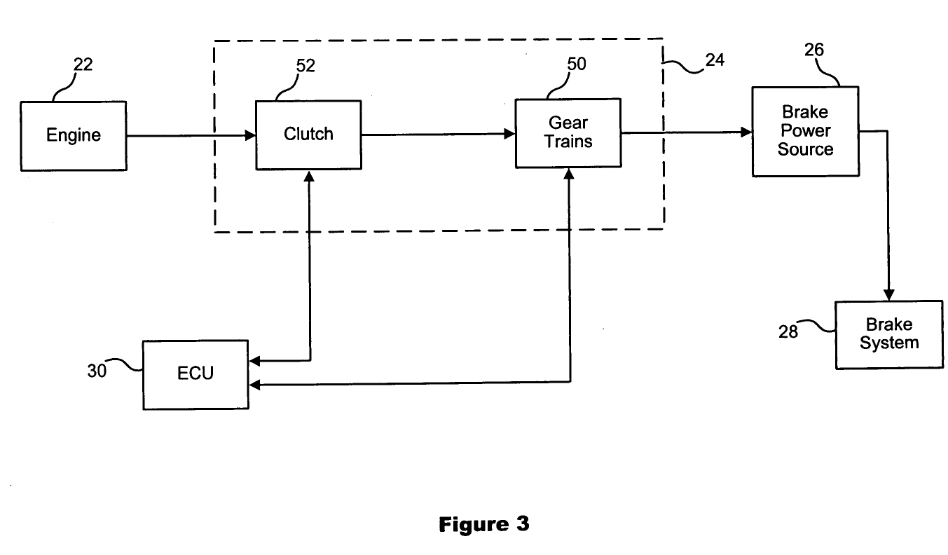

The basic components of another intermediate device 24 including two separately house components is illustrated in FIG. 3. This embodiment employs an arrangement of at least two gear trains 50 that are capable of driving the brake power source 26. The crankshaft of the engine 22 is connectable to the gear trains via a clutch 52, thereby enabling a switch between the different gear trains 50. By controlling the connection between the engine 22 and the different gear trains 50. In this way, the speed at which the brake power source 26 is driven can be changed.

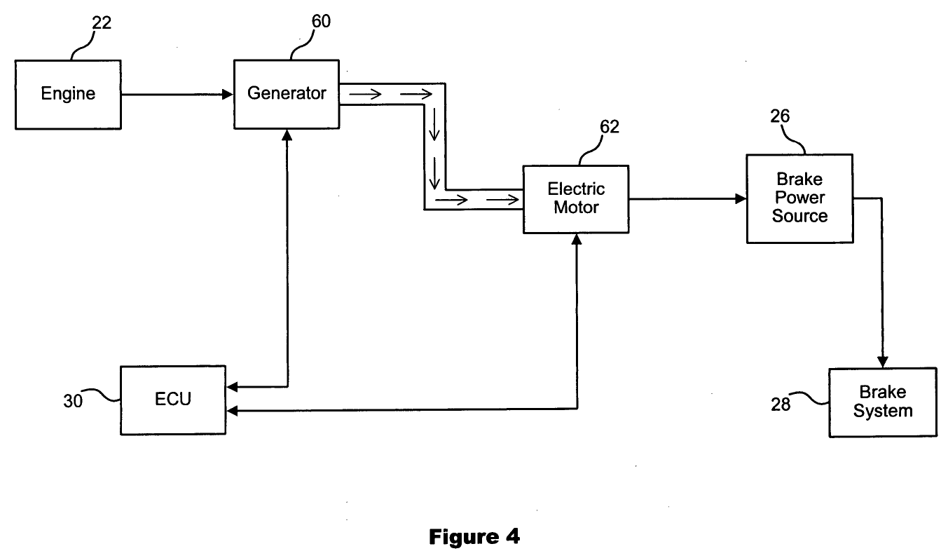

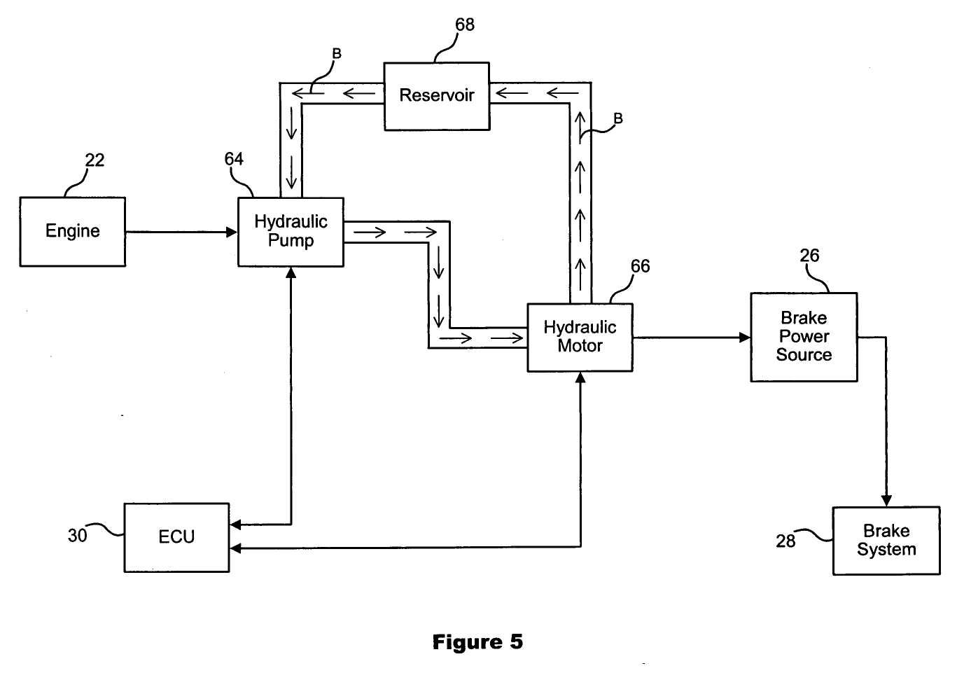

As illustrated in FIGS. 4-5, the arrangement in FIG. 2 (i.e. the supply device and motor) may take one of several different forms. For example, as illustrated in FIG. 4, the supply device may be a generator 60 for supplying electricity. In such cases, the motor is an electric motor 62, which is driven by the electricity supplied by the generator 60.

As another example, as illustrated in FIG. 5, the supply device may be a hydraulic pump 64 for supplying a fluid. In these cases, the motor is a hydraulic motor, which is driven by the fluid supplied by the hydraulic pump. The fluid is repeatedly returned to the hydraulic pump 64 (indicated by arrows B) for continued use by the hydraulic pump 64 to drive the hydraulic motor 66. In some embodiments, a reservoir 68 is provided in order to further facilitate the recycling of fluid in this manner.

The electronic control unit 30 regulates the operation of either the pump 64 or the motor 66, or both, in order to control the speed at which the motor 66 drives the brake power source 26. In this way, the speed at which the brake power source 26 is driven can be controlled irrespective of the current engine speed.

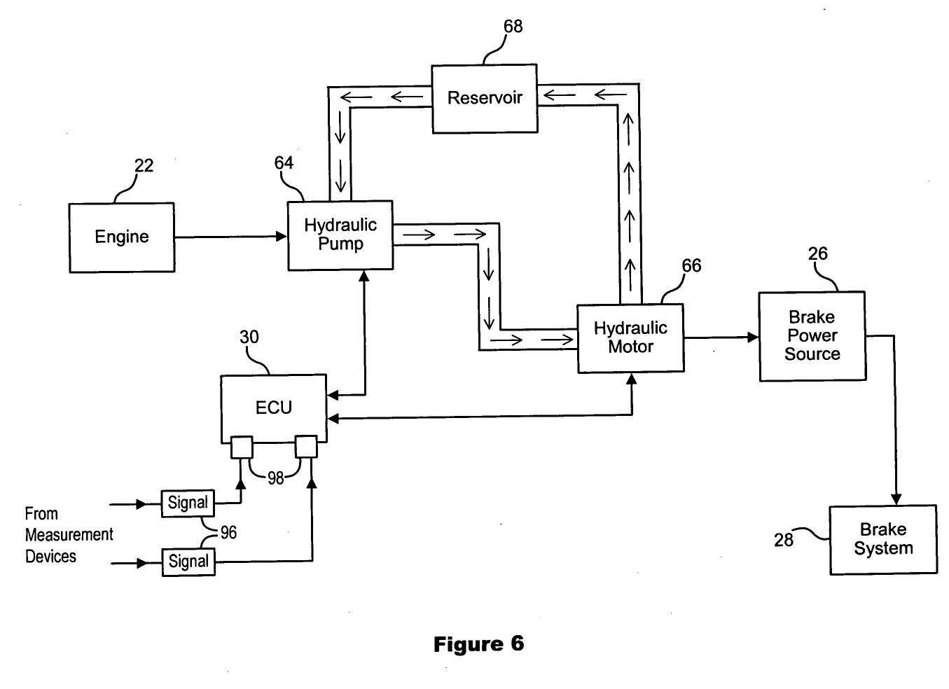

As illustrated in FIG. 6, in certain advantageous embodiments, the electronic control unit 30 controls the rate at which the intermediate device 24 drives the brake power source 26 based on one or more inputs 96. Inputs 96 may be inputs for receiving signals 98 containing information of any kind that may be desired. For example, a signal 98 may contain information reflecting the revolutions per minute of the engine's crankshaft so that the ECU can determine if the vehicle is traveling uphill or downhill. Similarly, a signal 98 may contain information reflecting throttle position so that the ECU can determine if the vehicle's operator desires to accelerate or decelerate. Similarly, a signal 98 may contain information reflection the rate of rotation of at least one wheel of vehicle so that the ECU can determine the vehicle's speed. Other signals 98 may carry a variety of other types of information, such as, for example, information reflecting air pressure, voltage, or the temperature in an air dryer. In some embodiments, the electronic control unit 30 may include an input 96 for receiving information reflecting the performance of the intermediate device 24 itself. For example, in certain embodiments, the electronic control unit 30 may include an input 96 for receiving a signal 98 containing information reflecting the speed of motor 66.

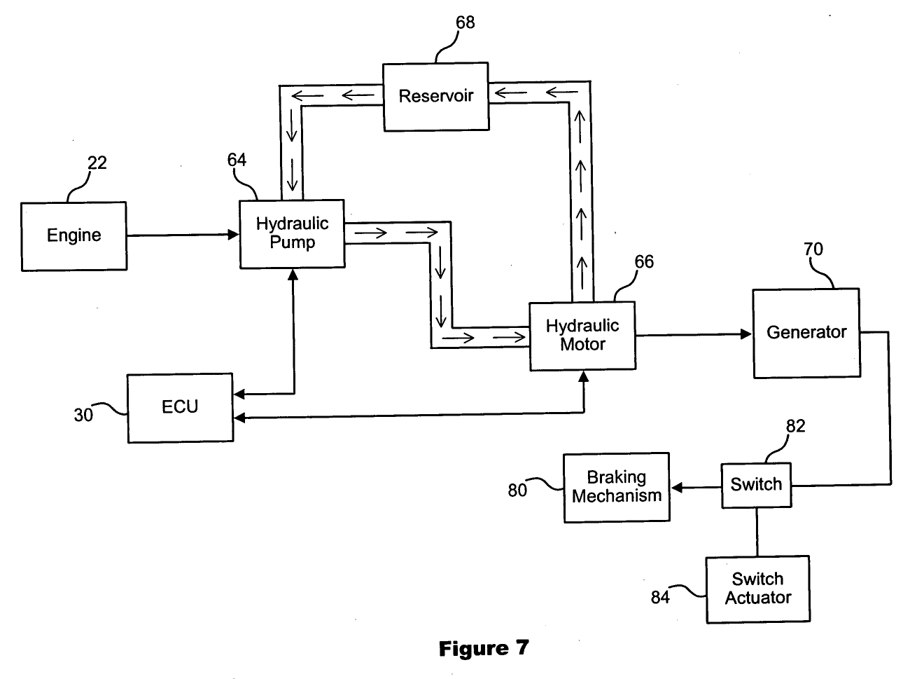

The brake power source 26 may be an electric, pneumatic, or other type of power source suitable for powering a brake system. For example, as illustrated in FIG. 7, in some embodiments, brake power 26 is a generator 70 for generating electricity. In these embodiments, the electricity is transferred to the braking mechanism 80. In certain of these embodiments, the transfer of this electricity is initiated or terminated, either automatically or by the operator of a vehicle, by turning a switch 82 on or off with a switch actuator 84, such as, for example, a brake pedal.

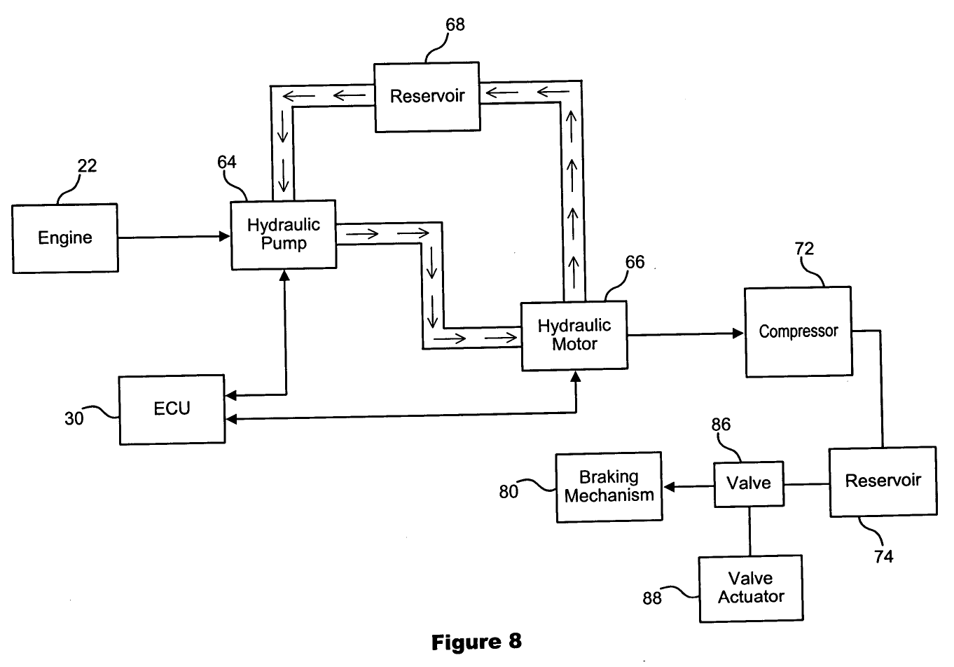

As illustrated in FIG. 8, in other embodiments, the brake power source 26 may be an air compressor 72. One such compressor may be a swash plate piston compressor, such as that disclosed in U.S. Pat. No. 6,439,857, incorporated herein by reference. As disclosed therein, a compressor of this type would typically include a swash plate housing at least partially enclosing a swash plate chamber mounted adjacent to a cylinder block having piston channels for receiving pistons that are coupled to a swash plate. The swash plate, which is disposed in the swash plate chamber, is mounted on shaft, as is an actuator for contacting the swash plate, such that the actuator, when in a first position, exerts a force on the swash plate appropriate to retain the swash plate in a position perpendicular to the drive shaft, such that the pistons remains idle, and, when in a second position, exerts a force on the swash plate appropriate to pivot the swash plate, thereby causing reciprocal motion of the pistons when the actuator rotates. In this embodiment, the shaft can be driven by the motor 66, irrespective of the speed of the engine 22.

In these embodiments, the air is transferred to the braking mechanism 80. In certain of these embodiments, the transfer of this air is initiated or terminated, either automatically or by the operator of a vehicle, by opening or closing a valve 86 with a valve actuator 88. In some of these embodiments, a reservoir 74 is provided in order to hold air compressed by the compressor 72 until it is needed, at which time the valve 86 is actuated with the valve actuator 88.

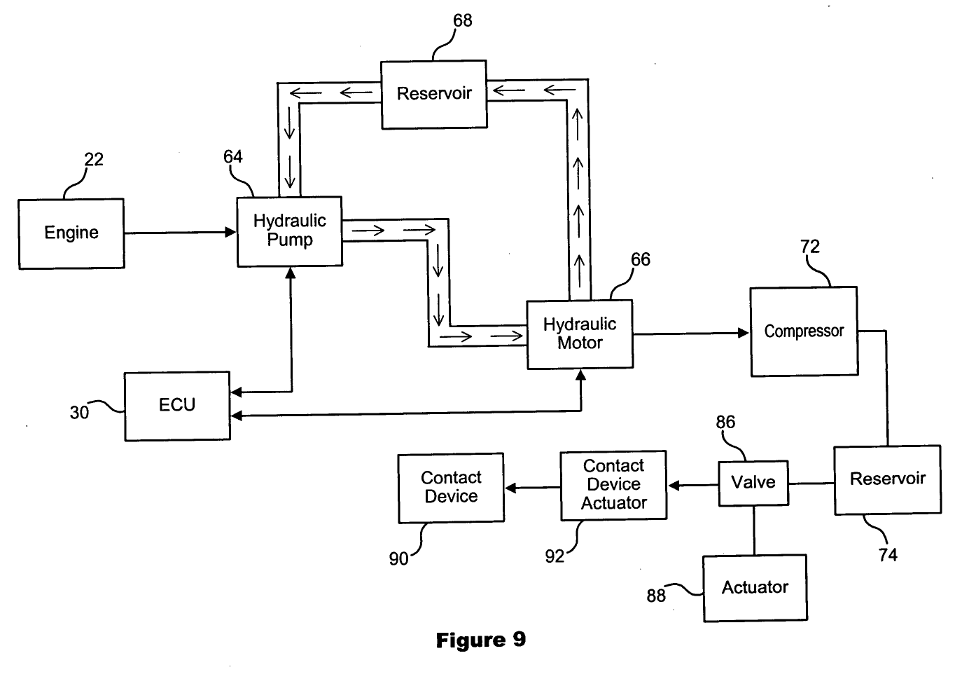

As illustrated in FIG. 9, the braking mechanism 80 may include a contact device 90 comprising any mechanism for effecting a frictional force sufficient to slow, stop, or restrain the rotation of the vehicle's wheels. For example, in some embodiments, the contact device 90 includes a caliper, such as a fixed-caliper or floating-caliper, for contacting a rotor (not shown) connected to the hub of the vehicle's wheel, exerting a frictional force thereon, and thereby inhibiting the wheel's ability to rotate. In other embodiments, the contact device 90 includes a brake drum having brake shoes therein that are forced outwardly to exert a frictional force on the drum and similarly inhibit its rotation.

In certain advantageous embodiments, the braking mechanism 80 also includes a separate contact device actuator 92 for actuating the device that actually creates the frictional force. In these embodiments, the actuator 92 receives the power from the brake power supply and, powered by it, supplies power in another form to the contact device 90.

The control of the brake power source 26 in this manner will often be valuable for its ability to determine when power is supplied to the brake system 28, such as in cases where the power is used to actuate the contact device 90. However, it should be noted that this control of the brake power source 26 is also valuable for its ability to determine when power will not be supplied to the brake system 28. Such instances occur when the power supplied by the brake power source 26 is used to prevent the braking mechanism 80 from braking the vehicle, and the braking mechanism 80 is actuated by interrupting the flow of power from the brake power source 26, such as, for example, in the case of a spring actuator where, during normal operation of the vehicle, compressed air is used to bias the spring and thereby prevent the spring from exerting a force on the contact device 90, and thus, the spring is only able to actuate the contact device when the flow of compressed air is interrupted.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

1. A system for regulating the supply of power to a vehicle's brake system, comprising:
an engine;
an intermediary device driven by said engine;
a brake power source driven by said intermediary device;
a brake system powered by said brake power source; and
a controller in communication with said intermediary device, said controller, in response to a minimum engine speed, causing said intermediary device to drive said brake power source at a desired rate.

2. The system as claimed in claim 1, wherein said controller is an electronic control unit.

3. The system as claimed in claim 1, wherein said brake power source is a source of pressurized fluid.

4. The system as claimed in claim 3, wherein said source of pressurized fluid is an air compressor.

5. The system as claimed in claim 4, wherein said air compressor is a swash plate compressor.

6. The system as claimed in claim 5, wherein said compressor comprises:
a cylinder block having at least one piston channel therein;
a swash plate housing mounted adjacent to said cylinder block;
a shaft disposed in said swash plate housing and cylinder block;
a swash plate mounted on said shaft;
at least one piston coupled to said swash plate and disposed in said at least one piston channel and slidable therein; and
an actuator contacting said swash plate, such that said actuator, in a first position, exerts a force on said swash plate appropriate to retain said swash plate in a position perpendicular to said drive shaft, such that said at least one piston remains idle, and, in a second position, exerts a force on said swash plate appropriate to pivot said swash plate, thereby causing reciprocal motion of said at least one piston when said actuator rotates.

7. The system as claimed in claim 3, wherein said brake system comprises:
a reservoir for receiving the pressurized fluid from said source of pressurized fluid;
a braking mechanism;
a valve connecting said reservoir to said braking mechanism; and
a valve actuator connected to said valve for governing the flow of the pressurized fluid from said reservoir to said braking mechanism.

8. The system as claimed in claim 7, wherein the vehicle includes a rotating surface and said braking mechanism comprises:
a contact device for contacting the rotating surface and thereby creating friction; and
a contact device actuator for causing said contact device to contact the rotating surface.

9. The system as claimed in claim 8, wherein said contact device comprises a fixed caliper.

10. The system as claimed in claim 8, wherein said contact device comprises a floating caliper.

11. The system as claimed in claim 8, wherein said contact device comprises a brake shoe.

12. The system as claimed in claim 8, wherein said contact device actuator comprises a piston.

13. The system as claimed in claim 8, wherein said contact device actuator comprises a spring.

14. The system as claimed in claim 1, wherein said brake power source is a source of electricity.

15. The system as claimed in claim 14, wherein said brake power source is an electric generator.

16. The system as claimed in claim 14, wherein said brake system comprises:
a braking mechanism;
a switch connecting said source of electricity to said braking mechanism; and
a switch actuator connected to said switch for governing the flow of the electricity from said source of electricity to said braking mechanism.

17. The system as claimed in claim 16, wherein the vehicle includes a rotating surface and said braking mechanism comprises a contact device for contacting the rotating surface and thereby creating friction.

18. The system as claim in claim 17, wherein said contact device comprises a fixed caliper.

19. The system as claimed in claim 17, wherein said contact device comprises a floating caliper.

20. The system as claimed in claim 17, wherein said contact device comprises a brake shoe.

21. The system as claimed in claim 1, wherein said intermediate device comprises at least two separately housed interconnected components.

22. The system as claimed in claim 21, wherein said intermediate device comprises:
a supply device driven by said engine for supplying an agency; and
a motor driven by the agency supplied by said supply device.

23. The system as claimed in claim 22, wherein:
said supply device comprises a generator for supplying electricity; and
said motor comprises an electric motor driven by the electricity.

24. The system as claimed in 22, wherein:
said supply device comprises a hydraulic pump for supplying fluid; and
said motor comprises a hydraulic motor driven by the fluid.

25. The system as claimed in claim 24, further comprising a reservoir for receiving fluid from said motor and from which said pump receives the fluid.

26. The system as claimed in claim 21, wherein said intermediate device comprises:
at least two gear trains; and
a clutch for switching from one of said gear trains to another of said gear trains.

27. The system as claimed in claim 1, wherein said controller has at least one input for receiving information, in response to which said controller determines the rate at which to cause the intermediate device to drive the brake power source.

28. The system as claimed in claim 27, wherein the at least one input comprises an input for receiving information reflecting the revolutions per minute of said engine's crankshaft.

29. The system as claimed in claim 27, wherein the at least one input comprises an input for receiving information reflecting throttle position.

30. The system as claimed in claim 27, wherein the at least one input comprises an input for receiving information reflecting the rate of rotation of at least one of the wheels.

31. The system as claimed in claim 27, wherein the at least one input comprises an input for receiving information reflecting air pressure.

32. The system as claimed in claim 27, wherein the at least one input comprises an input for receiving information reflecting voltage.

33. The system as claimed in claim 27, wherein the at least one input comprises an input for receiving information reflecting temperature in an air dryer.

33. The system as claimed in claim 27, wherein:
said intermediate device comprises
a supply device driven by said engine for supplying an agency; and
a motor driven by the agency supplied by said motor; and
the at least one input comprises an input for receiving information reflecting the speed of said motor.

35. A system for regulating the supply of power to a vehicle's brake system, comprising:
an engine;
an intermediary device driven by said engine;
a source of pressurized fluid driven by said intermediary device;
a brake system powered by said source of pressurized fluid; and
an electronic control unit in communication with said intermediary device, said controller, in response to a minimum engine speed, causing said intermediary device to drive said source of pressurized fluid at a desired rate.

36. The system as claimed in claim 35, wherein said intermediate device comprises:
a generator driven by said engine for supplying electricity; and
an electric motor driven by the electricity supplied said generator.

37. The system as claimed in 35, wherein said intermediate device comprises:
a hydraulic pump driven by said engine for supplying fluid; and
a hydraulic motor driven by the fluid.

38. The system as claimed in claim 35, wherein said intermediate device comprises:
at least two gear trains driven by said engine; and
a clutch for switching from one of said gear trains to another of said gear trains.

39. A system for regulating the supply of power to a vehicle's brake system, comprising:
an engine;
an intermediary device driven by said engine;
a source of electricity driven by said intermediary device;
a brake system powered by said source of electricity; and
an electronic control unit in communication with said intermediary device, said controller, in response to a minimum engine speed, causing said intermediary device to drive said source of electricity at a desired rate.

40. The system as claimed in 39, wherein said intermediate device comprises:
a hydraulic pump driven by said engine for supplying fluid; and
a hydraulic motor driven by the fluid.

41. The system as claimed in claim 39, wherein said intermediate device comprises:
at least two gear trains driven by said engine; and
a clutch for switching from one of said gear trains to another of said gear trains.
